(19) United States
(12) Patent Application Publication
(10) Pub. No.: US 2026/0005323 A1
(43) Pub. Date: Jan. 1, 2026

(54) NEGATIVE ELECTRODE SHEET, SECONDARY BATTERY COMPRISING NEGATIVE ELECTRODE SHEET AND METHOD FOR MANUFACTURING NEGATIVE ELECTRODE SHEET

(71) Applicant: TOYOTA JIDOSHA KABUSHIKI KAISHA, Aichi (JP)

(72) Inventors: Masashi UEDA, Toyota-shi (JP); Nariaki MIKI, Okazaki-shi (JP); Tomoko HIGO, Toyota-shi (JP); Hiroyuki YAMAGUCHI, Toyota-shi (JP); Akira KOHYAMA, Toyoake-shi (JP)

(21) Appl. No.: 19/241,376

(22) Filed: Jun. 18, 2025

(30) Foreign Application Priority Data
Jun. 27, 2024 (JP) 2024-104270

(51) Int. Cl. H01M 10/42; H01M 4/02; H01M 4/139; H01M 4/62; H01M 10/0525; H01M 10/0569

(52) U.S. Cl. CPC H01M 10/4235; H01M 4/139; H01M 4/623; H01M 10/0569; H01M 2004/027; H01M 10/0525

(57) ABSTRACT

A negative electrode sheet for a secondary battery using a non-aqueous electrolyte may include: a negative electrode active material; a binder; and an SEI forming agent. A standard electrode potential of the SEI forming agent may be higher than a standard electrode potential of the non-aqueous solvent included in the non-aqueous electrolyte.

### CROSS REFERENCE TO RELATED APPLICATIONS

This application claims priority from Japanese Patent Application No. 2024-104270 filed on Jun. 27, 2024. The entire content of the priority application is incorporated herein by reference.

### TECHNICAL FIELD

The technology disclosed herein relates to a negative electrode sheet and a method of manufacturing a negative electrode sheet.

### BACKGROUND ART

Japanese Patent Application Publication No. 2021-504877 describes a negative electrode sheet for a battery cell and a method of manufacturing a negative electrode sheet. The negative electrode sheet comprises a negative electrode active material and a binder. The method of manufacturing the negative electrode sheet comprises producing a negative electrode mixture by mixing the negative electrode active material and the binder, and producing the negative electrode sheet from the negative electrode mixture.

### SUMMARY

The above-mentioned negative electrode sheet is used, for example, in a negative electrode of a lithium-ion secondary battery that uses a non-aqueous electrolyte. In this secondary battery, it is known that during initial charging, non-aqueous solution and/or binder in the non-aqueous electrolyte are reductively decomposed to form a solid electrolyte interphase (SEI) on a surface of the negative electrode active material. Once SEI is formed on the surface of the negative electrode active material, the subsequent reductive decomposition of the non-aqueous solution and/or binder is suppressed. However, since the formation of SEI by reductive decomposition of non-aqueous solution and/or binder is an irreversible reaction, an initial charge-discharge efficiency of the secondary battery is reduced due to consumption of lithium ion in the reductive decomposition.

In view of the above circumstances, this specification provides a technique for suppressing reductive decomposition of a non-aqueous solvent and/or a binder in an initial charging of a secondary battery that uses a non-aqueous electrolyte.

The technology disclosed herein is embodied in a negative electrode sheet for a secondary battery using a non-aqueous electrolyte. In a first aspect thereof, the negative electrode sheet may comprise a negative electrode active material, a binder, and a solid electrolyte interphase (SEI) forming agent. A standard electrode potential of the SEI forming agent may be higher than a standard electrode potential of a non-aqueous solvent included in the non-aqueous electrolyte.

The negative electrode sheet described above comprises the SEI forming agent, and the standard electrode potential of said SEI forming agent is higher than the standard electrode potential of the non-aqueous solvent in the non-aqueous electrolyte. The SEI forming agent having a high standard electrode potential is more easily reduced than the non-aqueous solvent having a low standard electrode potential. Therefore, for example, in the initial charging of a secondary battery using the above-mentioned negative electrode sheet as the negative electrode, the SEI forming agent can be reductively decomposed without reductively decomposing the non-aqueous solvent by charging at a relatively low voltage. By preferentially forming SEI derived from the SEI forming agent on a surface of the negative electrode active material, the formation of SEI by reductive decomposition of the non-aqueous solvent can be suppressed. This can suppress the initial charge-discharge efficiency of the secondary battery from decreasing.

### BRIEF DESCRIPTION OF DRAWINGS

FIG. 1 illustrates a schematic diagram of a configuration of a battery 100.

FIG. 2 illustrates a schematic diagram of a configuration of an electrode body 108.

FIG. 3 illustrates a schematic diagram of a configuration of a negative electrode 114.

FIG. 4 illustrates an enlarged view of section IV shown in FIG. 3.

FIG. 5 illustrates a flowchart for explaining a manufacturing method of the negative electrode 114.

FIG. 6 illustrates a diagram for explaining a process of producing a negative electrode mixture by mixing graphite, PTFE, and LiBOB using a mixer 200.

FIG. 7 illustrates a diagram for explaining a process of forming the negative electrode mixture into a sheet shape using a roll press device 206.

FIG. 8 illustrates a diagram for explaining a process of compression-bonding a negative electrode active material sheet 10 and a negative electrode current collector 122 to each other using a flat plate press device 210.

FIG. 9 illustrates a flowchart for explaining a manufacturing method of a negative electrode material sheet and a negative electrode using the same of examples 1 to 3 and comparative example 1.

FIG. 10 illustrates amounts of respective raw materials and LiBOB in the negative electrode active material sheets of examples 1 to 3 and comparative example 1.

FIG. 11A illustrates a graph showing a relationship between a differential capacitance (dQ/dV) of a small cell and a voltage for each of the examples 1 to 3 and comparative example 1.

FIG. 11B illustrates results of evaluation of an initial charge-discharge efficiency of a small cell for each of examples 1 to 3 and comparative example 1.

FIG. 11C illustrates results of evaluation of an electrical resistance of a small cell (i.e., cell resistance) for each of examples 1 to 3 and comparative example 1.

### DETAILED DESCRIPTION

In a second aspect, in the first aspect, the non-aqueous solvent may be ethylene carbonate (EC). The standard electrode potential of ethylene carbonate is higher than that of polytetrafluoroethylene (PTFE), which can be used as a binder. Therefore, in the initial charging of a secondary battery using the above-mentioned negative electrode sheet as the negative electrode, the SEI forming agent can be reductively decomposed without reductively decomposing the non-aqueous solvent and binder by charging at a relatively low voltage. This suppresses the initial charge-discharge efficiency of the secondary battery from decreasing.

In a third aspect, in the above-mentioned first or second aspect, the binder may include at least polytetrafluoroethylene (PTFE). PTFE can be fibrillated by applying shear force. Therefore, according to the above configuration, a tensile strength of the negative electrode sheet can be improved.

In the fourth aspect, in any of the above-mentioned first to the third aspects, the SEI forming agent may be a compound containing lithium. In order to suppress reductive decomposition of the non-aqueous solvent and/or binder, the surface of the negative electrode active material may be coated with a binder to reduce an exposed area of the negative electrode active material. However, coating the surface of the negative electrode active material with the binder may increase the electrical resistance of the negative electrode active material sheet due to the electrical resistance of the binder. In this regard, when the SEI forming agent is a lithium-containing compound, the SEI formed by the reduction reaction of the SEI forming agent has a characteristic of lower electrical resistance compared to a binder that coats the surface of the negative electrode active material. Therefore, according to the configuration described above, in the initial charging of a secondary battery using the negative electrode sheet as the negative electrode, the reduction decomposition of the non-aqueous solvent and/or binder can be suppressed, and the increase in electrical resistance of the secondary battery can also be suppressed.

In the fifth aspect, in any of the first to the fourth aspects, the SEI forming agent may be at least one selected from the group consisting of lithium bis (oxalato) borate, lithium difluoro (oxalato) borate, and 1,3-propanesultone. These SEI forming agents are water-soluble and can be suitably used for manufacturing a negative electrode sheet by a so-called dry process.

The technology disclosed herein is also embodied in a secondary battery. In its sixth aspect thereof, the secondary battery may comprise: a positive electrode; a negative electrode which comprises the negative electrode sheet according to any one of the first to fifth aspects; and a non-aqueous electrolyte which includes ethylene carbonate. According to this configuration, as described above, the initial charge-discharge efficiency of the secondary battery using the negative electrode sheet of the present technology for the negative electrode can be suppressed.

The technology disclosed herein is also embodied in a method of manufacturing a negative electrode sheet for a secondary battery using a non-aqueous electrolyte. In a seventh aspect thereof, the manufacturing method may comprise: producing a negative electrode mixture by mixing a negative electrode active material with a binder and a solid electrolyte interphase (SEI) forming agent; and producing the negative electrode sheet from the negative electrode mixture. A standard electrode potential of the SEI forming agent may be higher than a standard electrode potential of a non-aqueous solvent included in the non-aqueous electrolyte.

When the negative electrode sheet manufactured by the above manufacturing method is used for the negative electrode of a secondary battery, for example, the initial charge-discharge efficiency of the secondary battery can be suppressed, as described above.

In an eighth aspect, in the seventh aspect, the binder may include polytetrafluoroethylene. In this case, at least of a part of the polytetrafluoroethylene may be fibrillated in the producing of the negative electrode mixture. According to this configuration, the tensile strength of the negative electrode sheet can be improved.

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved negative electrode sheets and secondary batteries comprising the same, as well as methods for manufacturing the negative electrode sheets.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

With reference to the drawings, a negative electrode active material sheet 10 of an embodiment will be described. The negative electrode active material sheet 10 of this embodiment, together with a negative electrode current collector 122, constitutes a negative electrode 114 of a battery 100. The battery 100 is, for example, a lithium-ion secondary battery.

### Battery

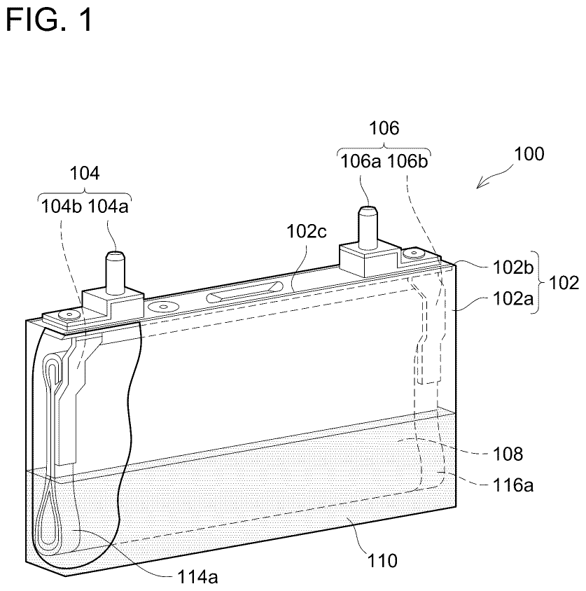

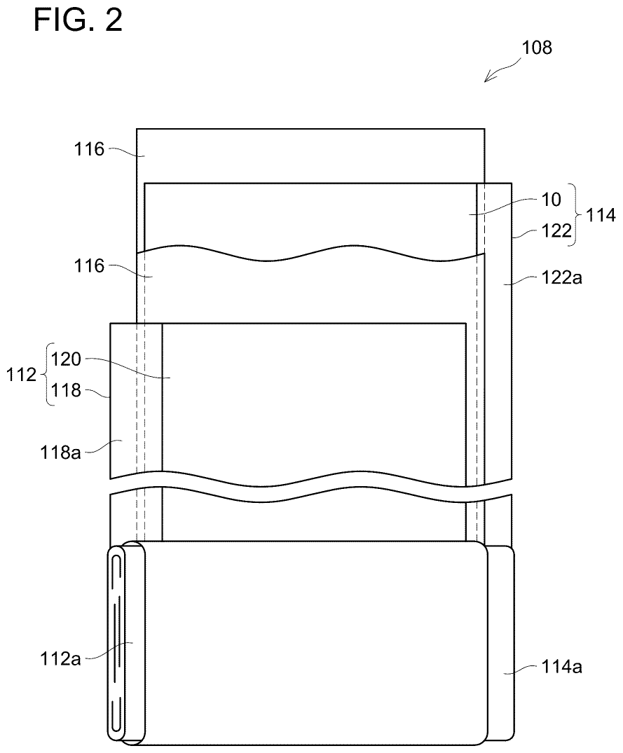

As shown in FIGS. 1 and 2, the battery 100 comprises a housing 102, a positive terminal 104, a negative terminal 106, an electrode body 108, and a non-aqueous electrolyte 110. The housing 102 houses an electrode body 108 and the non-aqueous electrolyte 110. The housing 102 comprises a housing body 102a and a cover plate 102b. The housing body 102a is a housing with an opening 102c at its top. The cover plate 102b is a plate-shaped component. The cover plate 102b is attached to the opening 102c and seals the opening 102c. The housing body 102a and the cover plate 102b are constructed using metal, such as aluminum.

Each of the positive terminal 104 and the negative terminal 106 is attached to the cover plate 102b. One end 104a of the positive terminal 104 is exposed to outside of the housing 102, and another end 104b of the positive terminal 104 is connected to a positive electrode connection part 112a of the electrode body 108 in the housing 102. One end 106a of the negative terminal 106 is exposed outside the housing 102, and the other end 106b of the negative terminal 106 is connected to a negative electrode connection part 114a of the electrode body 108 within the housing 102.

### Electrode Body

As shown in FIG. 2, the electrode body 108 comprises a positive electrode 112, a negative electrode 114, and a separator 116. Each of the positive electrode 112, the negative electrode 114, and the separator 116 is in a form of a long sheet. The positive electrode 112 and the negative electrode 114 are laminated via the separator 116, and the laminated body is wound to form the electrode body 108. That is, the electrode body 108 in this embodiment is a so-called wound electrode body. However, the electrode body 108 does not necessarily have to be a wound electrode body. For example, the electrode body 108 may be a so-called stacked electrode body, in which a plurality of positive electrodes 112 and a plurality of negative electrodes 114 are alternately stacked with a separator 116 interposed therebetween.

### Positive Electrode

As shown in FIG. 2, the positive electrode 112 comprises a positive electrode current collector 118 and a positive electrode active material sheet 120. The positive electrode current collector 118 is a conductive sheet. The positive electrode current collector 118 is, for example, an aluminum foil. The positive electrode active material sheet 120 is disposed on a surface of the positive electrode current collector 118. One side edge in a width direction of the positive electrode 112 has a positive electrode exposed portion 118a where the positive electrode active material sheet 120 is not provided and the positive electrode current collector 118 is exposed.

The positive electrode exposed portion 118a forms the positive electrode connection part 112a by being wound and stacked each another in a state of protruding from the negative electrode 114 when the electrode body 108 is being formed. A thickness of the positive electrode current collector 118 is, for example, 5 μm or more and 50 μm or less. The thickness of the positive electrode active material sheet 120 is, for example, 10 μm or more and 500 μm or less.

The positive electrode active material sheet 120 comprises a positive electrode active material. Examples of the positive electrode active material may include a lithium composite oxide. Examples of the lithium composite oxide may include lithium nickel composite oxide, lithium cobalt composite oxide, lithium manganese composite oxide, lithium nickel manganese composite oxide (e.g. LiNi_{1/2}Mn_{3/2}O₄), lithium nickel manganese cobalt composite oxide (e.g, LiNi_{1/3}Mn_{1/3}Co_{1/3}O₂), etc. The positive electrode active material may be composed of a single material or multiple materials. The positive electrode active material sheet 120 may further comprise a binder, conductivity aid, or the like.

### Negative Electrode

As shown in FIG. 2, the negative electrode 114 comprises a negative electrode current collector 122 and a negative electrode active material sheet 10. The negative electrode current collector 122 is a conductive sheet. The negative electrode current collector 122 is, for example, a copper foil. The negative electrode active material sheet 10 is disposed on a surface of the negative electrode current collector 122. One side edge in the width direction of the negative electrode 114 has a negative electrode exposed portion 122a where the negative electrode active material sheet 10 is not provided and the negative electrode current collector 122 is exposed. The negative electrode exposed portion 122a forms the negative electrode connection portion 114a by being wound and stacked on each other in a state of protruding from the positive electrode 112 when the electrode body 108 is being formed. A thickness of the negative electrode current collector 122 is, for example, 5 μm or more and 50 μm or less. A thickness of the negative electrode active material sheet 10 is, for example, 10 μm or more and 500 μm or less.

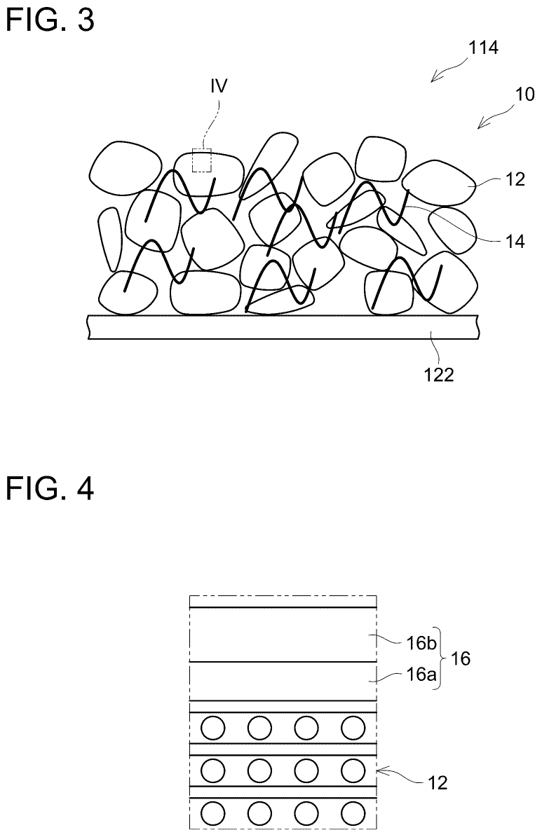

As shown in FIGS. 3 and 4, the negative electrode active material sheet 10 comprises a negative electrode active material 12, a binder 14, and a solid electrolyte interphase (SEI) 16. Examples of the negative electrode active material 12 may include carbon materials such as graphite, hard carbon, soft carbon, etc., materials that form an alloy with lithium such as silicon (Si), lithium alloys of these (Li_{X}M, where Mis C, Si, Sn, Sb, Al, Mg, Ti, Bi, Ge, Pb, or P, etc., where X is a natural number). The negative electrode active material 12 may be composed of a single material or multiple materials. An average particle diameter of the negative electrode active material 12 is not particularly limited, but is, for example, 5 μm or more and 50 μm or less. The average particle diameter here means a particle diameter at 50% integration value (D50) in a volume-based particle size distribution measured by laser diffraction and scattering method.

Examples of the binder 14 may include carboxymethyl cellulose (CMC), styrene-butadiene rubber (SBR), polyvinylidene fluoride (PVdF), and polytetrafluoroethylene (PTFE). The binder 14 may be composed of a single material or multiple materials. The binder 14 in this embodiment is PTFE, which can be fibrillated by applying shear force. Therefore, in the negative electrode active material sheet 10, the binder 14, PTFE, is fibrillated. This can improve a tensile strength of the negative electrode active material sheet 10.

As shown in FIG. 4, the SEI 16 is formed on a surface of the negative electrode active material 12 during initial charging of the battery 100.

The negative electrode active material sheet 10 may further comprise a conductivity aid or the like.

### Separator

The separator 116 is configured to allow charge carriers (in this case, lithium ions) to pass through. Examples of the separator 116 may include porous polymer membrane such as porous polyethylene membranes, porous polypropylene membrane, porous polyolefin membrane, porous polyvinyl chloride membrane, and lithium ion-conductive polymer electrolyte membrane. The separator 116 of these types may be used alone or may be used in combination.

### Non-aqueous Electrolyte

The non-aqueous electrolyte 110 permeates interior of the electrode body 108. The non-aqueous electrolyte 110 includes a non-aqueous solvent and a supporting salt. Examples of the non-aqueous solvent may include carbonate solvents, ester solvents, nitrile solvents, sulfone solvents, and lactone solvents. Examples of the carbonate solvents may include ethylene carbonate (EC), propylene carbonate (PC), diethyl carbonate (DEC), dimethyl carbonate (DMC), ethyl methyl carbonate (EMC), monofluoroethylene carbonate (MFEC), etc. Examples of the supporting salt may include fluorine-containing lithium salt. Examples of the fluorine-containing lithium salt may include LiPF₆, LiBF₄, LiCF₃SO₃, etc. Thus, the non-aqueous electrolyte 110 includes a lithium compound. Each of the non-aqueous solvent and support salt may be composed of a single material or multiple materials. A concentration of the support salt in the non-aqueous electrolyte 110 is, for example, 0.75 mol/L or more and 1.5 mol/L or less.

In the battery 100 described above, it is known that during initial charging, the non-aqueous solvent and/or binder 14 in the non-aqueous electrolyte 110 is reductively decomposed to form the SEI 16 on the surface of the negative electrode active material 12. Once the SEI 16 is formed on the surface of the negative electrode active material 12, subsequent reductive decomposition of the non-aqueous solvent and/or binder 14 is suppressed. However, since the formation of the SEI 16 by reductive decomposition of the non-aqueous solvent and/or binder 14 is an irreversible reaction, the initial charge-discharge efficiency of the battery 100 is reduced due to consumption of lithium ions in said reductive decomposition.

In this regard, before the battery 100 is initially charged as described above, the negative electrode active material sheet 10 comprises an SEI forming agent instead of the SEI 16. The standard electrode potential of the SEI forming agent is higher than the standard electrode potential of the non-aqueous solvent in the non-aqueous electrolyte 110. The SEI forming agent having a high standard electrode potential is more easily reduced than the non-aqueous solvent having a low standard electrode potential. Therefore, in the initial charging of the battery 100, the SEI forming agent can be reductively decomposed without reductively decomposing the non-aqueous solvent by charging at a relatively low voltage. By preferentially forming the first SEI 16a derived from the SEI forming agent on the surface of the negative electrode active material 12, formation of a second SEI 16b by the reductive decomposition of the non-aqueous solvent is suppressed, and the initial charge-discharge efficiency of the battery 100 is reduced. Thus, the SEI 16 of this embodiment has a first SEI 16a formed by the reductive decomposition of the SEI forming agent and the second SEI 16b formed by the reductive decomposition of except for SEI forming agent (e.g., non-aqueous solvent) (see FIG. 4).

Examples of the SEI forming agent may include lithium bisoxalate borate (LiBOB), lithium difluorooxalate borate (LiDFOB), and 1,3-propanesultone. These SEI forming agents are water soluble and can be suitably used when producing the negative electrode active material sheet 10 by so-called dry process. The SEI forming agent may be composed of a single material or multiple materials.

In addition, the standard electrode potential of the SEI forming agent is preferably higher than the standard electrode potential of the material comprising the binder 14. In this case, the SEI forming agent is more easily reduced than the binder 14. Therefore, in the initial charging of the battery 100, the SEI forming agent can be reductively decomposed without reductively decomposing the binder 14 by charging at a relatively low voltage. By preferentially forming the first SEI 16a derived from the SEI forming agent on the surface of the negative electrode active material 12, the formation of the second SEI 16b by the reductive decomposition of the binder 14 is also suppressed, and the initial charge-discharge efficiency of the battery 100 is suppressed.

Although this is an example, in the embodiment described above, the non-aqueous solvent may be ethylene carbonate (EC). A material comprising the binder 14 may be polytetrafluoroethylene (PTFE) The standard electrode potential of EC is higher than that of PTFE. Therefore, the standard electrode potential of the SEI forming agent is preferably higher than the standard electrode potential of EC. In the initial charging of the battery 100 described above, the SEI forming agent can be reductively decomposed without reductively decomposing the non-aqueous solvent and binder 14 by charging at a relatively low voltage. This suppresses the initial charge-discharge efficiency of the battery 100 from decreasing.

The standard electrode potential of EC is higher than the standard electrode potential of another non-aqueous solvent (e.g., dimethyl carbonate, ethyl methyl carbonate) in the non-aqueous electrolyte 110. Therefore, if the standard electrode potential of the SEI forming agent is higher than the standard electrode potential of EC, the standard electrode potential of the SEI forming agent is considered to be higher than that of all the non-aqueous solvents in the non-aqueous electrolyte 110. In the initial charging of the battery 100 described above, it is believed that charging at a relatively low voltage will allow the SEI forming agent to be reductively decomposed without reductively decomposing all the non-aqueous solvents contained in the non-aqueous electrolyte 110.

Although this is an example, in this embodiment described above, a lithium-containing compound such as lithium bisoxalate borate (LiBOB), lithium difluorooxalate borate (LiDFOB), etc. may be used as the SEI forming agent. In order to suppress the reductive decomposition of the non-aqueous solvent and/or binder 14, the surface of the negative electrode active material 12 may be coated with the binder 14 to reduce the exposed area of the negative electrode active material 12. However, coating the surface of the negative electrode active material 12 with the binder 14 may increase the electrical resistance of the negative electrode active material sheet 10 due to the electrical resistance of the binder 14. In this regard, when the SEI forming agent is a lithium-containing compound, the first SEI 16a formed by the reduction reaction of the SEI forming agent has a characteristic of low electrical resistance compared to the binder 14 coating the surface of the negative electrode active material 12. Therefore, according to the configuration described above, the reduction decomposition of the non-aqueous solvent and/or the binder 14 can be suppressed during the initial charging of the battery 100, and the increase in the electrical resistance of the battery 100 can be suppressed.

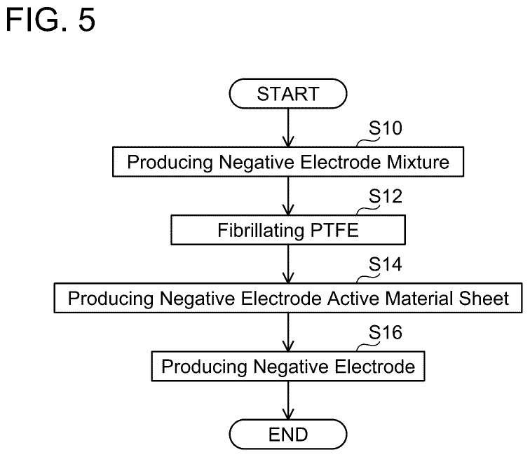

Referring now to FIGS. 5-8, a method of manufacturing the negative electrode 114 comprising the negative electrode active material sheet 10 of this embodiment will be described. In this manufacturing method, the negative electrode 114 can be manufactured without using any solvent. That is, said manufacturing method is a so-called dry process.

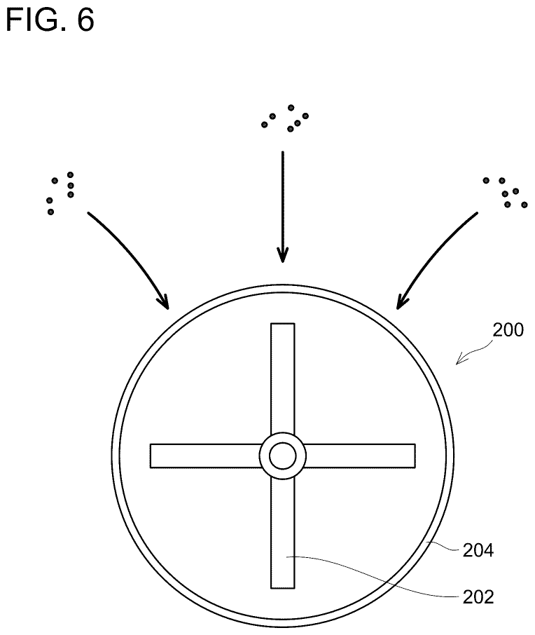

As shown in FIG. 5, the manufacturing method comprises a process of mixing a negative electrode active material 12, a binder 14, and an SEI forming agent (S10). In this process, a mixer 200 is used, for example, as shown in FIG. 6. The mixer 200 mixes the negative electrode active material 12, the binder 14, and the SEI forming agent fed into a container 204 by rotating blades 202. As a result, the negative electrode mixture is produced. In S10, the mixer 200 may not be necessarily used. In other embodiments, another mixer such as a blender or a mill may be used instead of the mixer 200.

As shown in FIG. 5, the manufacturing method further comprises a process of fibrillating the binder 14 by applying shear force to the negative electrode mixture (S12). In this process, a mixer is used, for example, as shown in FIG. 6. The mixer applies shear force to the negative electrode mixture fed into the container by rotating the blades. As mentioned above, since the binder 14 in this embodiment is PTFE, the PTFE is fibrillated by the shear force applied to the binder 14 (i.e., PTFE) comprising the negative electrode mixture. This can improve the tensile strength of the negative electrode active material sheet 10. In S12, the mixer may not be necessarily used. In other embodiments, another mixer such as a blender, a mill, a kneader, etc. may be used instead of the mixer 200.

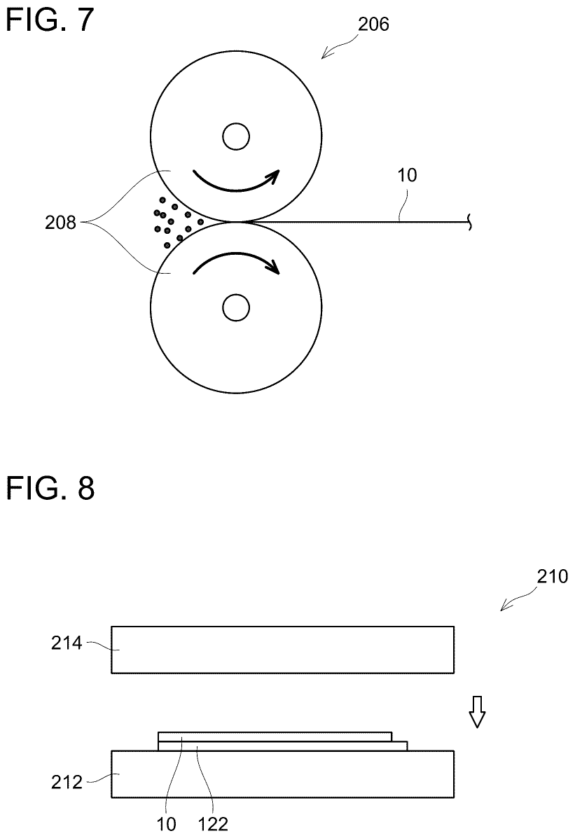

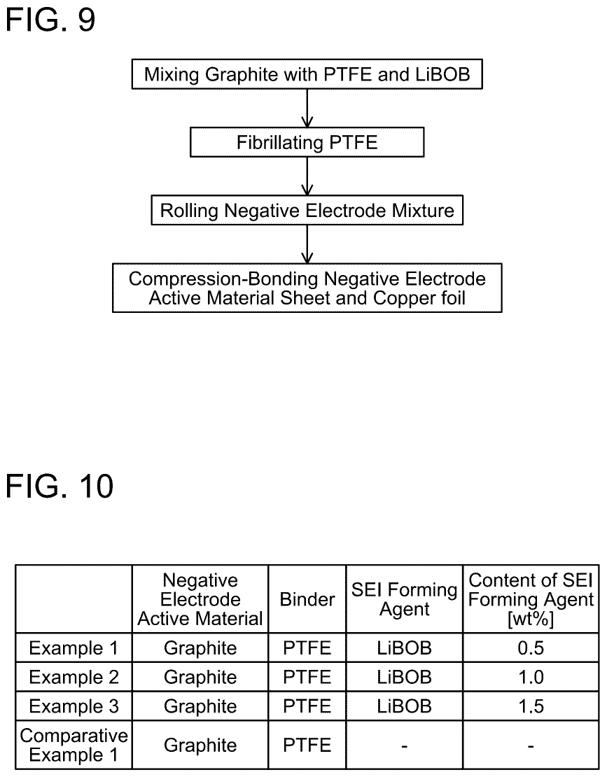

As shown in FIG. 5, the manufacturing method further comprises a process of producing the negative electrode active material sheet 10 from the negative electrode mixture (S14). In this process, a roll press device 206 is used, for example, as shown in FIG. 7. The roll press device 206 comprises a pair of rollers 208 and is configured to roll the negative electrode mixture passing between the pair of rollers 208. Therefore, the negative electrode mixture is formed into a sheet shape by being rolled by the pair of rollers 208. Thereby, the negative electrode active material sheet 10 is produced.

As shown in FIG. 5, the manufacturing method further comprises a process of compression-bonding the negative electrode active material sheet 10 and the negative electrode current collector 122 to each other (S16). In this process, a flat plate press device 210 is used, for example, as shown in FIG. 8. The flat plate press device 210 comprises a lower die 212 and an upper die 214, and the upper die 214 can be lowered toward the lower die 212. The negative electrode active material sheet 10 and the negative electrode current collector 122 are placed on the lower die 212 in an overlapped state, and the upper die 214 is lowered to compression-bond the negative electrode active material sheet 10 and the negative electrode current collector 122 to each other. As a result, the negative electrode 114 is manufactured. Although not limited, the process of S16 may be performed with the lower die 212 and the upper die 214 heated at a predetermined temperature.

A content of the negative electrode active material 12 in the negative electrode mixture is, for example, 90 weight % or more and 99 weight % or less, and 95 weight % or more and 98.5 weight % or less, based on a total weight of the negative electrode active material 12 and the binder 14 (100 weight %). A content of the binder 14 in the negative electrode mixture is, for example, 0.5 weight % or more and 5 weight % or less, and 1 weight % or more and 4 weight % or less, based on the total weight of the negative electrode active material 12 and the binder 14 (100 weight %). A content of the SEI forming agent in the negative electrode mixture is, for example, 0.25 weight % or more and 3 weight % or less, and 0.5 weight % or more and 2 weight % or less, based on the total weight of the negative electrode active material 12 and the binder 14 (100 weight %).

The negative electrode active material sheet 10 produced by the above manufacturing method comprises the SEI forming agent, and the standard electrode potential of said SEI forming agent is higher than the standard electrode potential of the non-aqueous solvent included in the non-aqueous electrolyte 110. Therefore, in the battery 100 using said negative electrode active material sheet 10 as the negative electrode 114, a decrease in the initial charge efficiency can be suppressed. The negative electrode active material sheet 10 in this specification is an example of the negative electrode sheet in the present technology.

Hereafter, some examples of the technology disclosed herein will be described, but they are not intended to limit the technology to what is shown in such examples.

### Example 1

### (Production of Positive Electrode)

LiCo_{1/3}Ni_{1/3}Mn_{1/3}O₂ (hereinafter referred to as NCM, product name: NCM811) as positive electrode active material particles, carbonnanotube (CNT, LG Chem) powder as a conductive aid, and polyvinylidene fluoride (PVdF, Arkema) powder as a binder, was put at NCM:CNT:PVdF=98.3:0.7:1.0 weight ratio into a mixer (MP5B, Nippon Coke Co., Ltd.) and mixed with solvent. Paste for producing a positive electrode mixture was thus prepared. The paste for producing the positive electrode mixture was applied to a surface of aluminum foil (thickness: 12 μm) as the positive electrode current collector 118 and dried to produce the positive electrode 112.

### (Production of Negative Electrode)

First, graphite (average particle size: 20 μm) powder as the negative electrode active material 12, polytetrafluoroethylene (PTFE, Chemers) powder as the binder 14, and lithium bisoxalate borate (LiBOB) powder as the SEI forming agent were mixed in a mixer (MP5B, Nippon Coke Co.) and mixed at 300 rpm for 180 seconds. The negative electrode mixture was thus produced. As shown in FIG. 10, a weight ratio of graphite:PTFE:LiBOB was 97:3:0.5 based on the total weight of graphite and PTFE (100 weight %). The negative electrode mixture was mixed at 3000 rpm for 8 minutes in the above mixer. This gave shear force to the PTFE and fibrillated the PTFE. The negative electrode mixture was then rolled with a roll press device (Tester Sangyo, SA-602) at a linear pressure of 0.4 t/cm to produce the negative electrode active material sheet 10. The thickness of the negative electrode active material sheet 10 was 110 μm.

The negative electrode 114 was manufactured by pressing the negative electrode active material sheet 10 and the copper foil (thickness: 8 μm) as the negative electrode current collector 122 against each other with a load 5 t while being heated to 160° C. in a flat plate press device (As-one, H300-05K).

### (Preparation of Non-Aqueous Electrolyte)

Ethylene carbonate (EC), dimethyl carbonate (DMC), and ethyl methyl carbonate (EMC) as non-aqueous solvents were mixed at a volume ratio of EC:DMC:EMC=30:30:40. LiPF₆ was dissolved in the non-aqueous solvent as a supporting salt to a concentration of 1.1 mol/L to produce the non-aqueous electrolyte 110.

### (Production of Small Cell)

The positive electrode 112, the negative electrode 114, and the separator for lithium-ion batteries as the separator 116 were assembled into a small coin-type cell and filled with non-aqueous electrolyte 110 to produce a small cell.

### Example 2

Example 2 was the same as example 1, except that in example 2, the weight ratio of graphite:PTFE:LiBOB was 97:3:1.0, based on the total weight of graphite and PTFE (100 weight %).

### Example 3

Example 3 was the same as example 1, except that in example 3, the weight ratio of graphite:PTFE:LiBOB was 97:3:1.5, based on the total weight of graphite and PTFE (100 weight %).

### Comparative Example 1

Comparative example 1 was the same as example 1, except that in comparative example 1, the weight ratio of graphite:PTFE was 97:3, based on the total weight of graphite and PTFE (100 weight %).

Differential Capacitance (dQ/dV)—Voltage Characteristic Curve

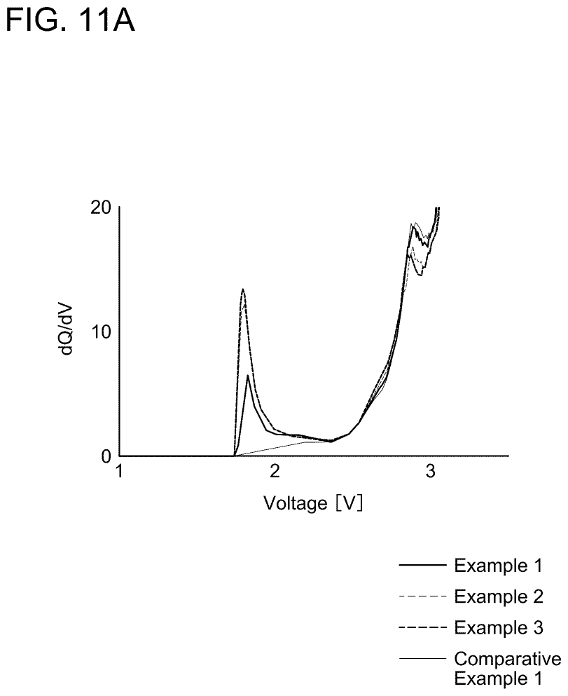

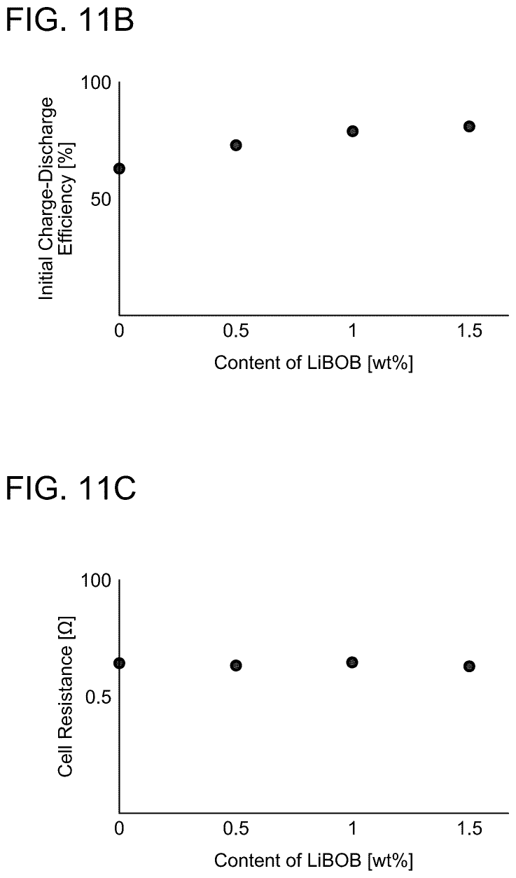

Each of the produced small cells was initially charged by CCCV charging. Specifically, constant current (CC) charging was performed at a current rate of 0.1 C until the voltage between the positive electrode 112 and negative electrode 114 reached 4.25 V, followed by constant voltage (CV) charging at the same voltage. The voltage between the positive electrode 112 and negative electrode 114 at the start of charging was 3.0 V. From the charge curve in this initial charge, the differential capacity (dQ/dV) obtained by differentiating the charge capacity by voltage was calculated. The results are shown in FIG. 11A, where conditions for CCCV charging were a CC current of 0.1 C and a CV voltage of 4.25V. A unit “C” for a current rate indicates a current rate at which a rated capacity of the small cell is discharged in one hour.

The differential capacitance (dQ/dV) is an indicator of reaction amount of the SEI formation, and the larger the said differential capacitance is, the more SEI formation is in progress. As shown in FIG. 11A, in the dQ/dV-voltage characteristic curve of the initial charge of each small cell in examples 1 to 3, two peaks mainly originating from the SEI formation were identified. The first and second peaks are referred to as the first and second peaks, respectively, in an ascending order of voltage. Sub-peaks were observed between the first and second peaks. In the dQ/dV-voltage characteristic curve of the small cell of comparative example 1 during initial charging, the first peak was not observed, and only the second peak and the subpeak described above were observed.

The standard electrode potentials increase for PTFE, EC, and LiBOB, in this order. The higher the standard electrode potential, the more likely it is to be reductively decomposed in the initial charging of the small cell, i.e., it is considered to be reductively decomposed at a lower potential. Therefore, the first peak is considered to be a peak derived from the SEI formation by the reductive decomposition of LiBOB, the sub-peak is considered to be a peak derived from the SEI formation by the reductive decomposition of EC, and the second peak is considered to be a peak derived from the SEI formation by the reductive decomposition of PTFE.

The results shown in FIG. 11A indicate that the higher the content of LiBOB, the higher the first peak. It can be said that the more the LiBOB content increases, the more the formation of the first SEI 16a derived from LiBOB progresses. It was also found that the more the LiBOB content increases, the lower the second peak becomes. It can be said that the formation of the second SEI 16b derived from PTFE is suppressed as the content of LiBOB increases. This is considered to be because the formation of the first SEI 16a derived from LiBOB preferentially progresses and the formation of the second SEI 16b derived from PTFE is suppressed. Furthermore, it can be said that the SEI formation due to reductive decomposition of EC is hardly progressing in any of the small cells in examples 1 to 3 and comparative example 1.

### Initial Charge-Discharge Efficiency

For each small cell produced, initial charge-discharge was performed by charging at a constant current (CC) to 4.25 V at a 0.1 C rate and then discharging to 3.0 V at a 0.1 C rate. A ratio of a discharging capacity to a capacity for charging, i.e., the initial charge-discharge efficiency, was calculated. The results are shown in FIG. 11B.

The results shown in FIG. 11B indicate that the initial charge-discharge efficiency of each of the small cells in examples 1 to 3 is higher than the initial charge-discharge efficiency of the small cell in comparative example 1. Furthermore, comparison between the initial charge-discharge efficiencies of the respective small cells in examples 1 to 3 shows that the initial charge-discharge efficiencies of the small cells become higher as the content of LiBOB increases. This is considered to be because a thicker film of the first SEI 16a formed by the reductive decomposition of LiBOB as the LiBOB content increased suppressed the reductive decomposition of PTFE that occurs after the reductive decomposition of LiBOB. This is considered to have reduced the amount of lithium ions consumed in the reductive decomposition of PTFE, resulting in decrease in the irreversible capacity of the small cell and increase in the initial charge-discharge efficiency. Cell Resistance

The electrical resistance (i.e., cell resistance) was measured for each small cell produced. Specifically, the cell resistance was calculated from a voltage drop (AV) when the SOC was adjusted to 50% and then electricity was discharged for 10 seconds at a current rate of 0.3C. The results are shown in FIG. 11C.

The results shown in FIG. 11C indicate that the cell resistance is almost constant regardless of the LiBOB content. On the other hand, the inventors confirmed that the electrical resistance of the negative electrode active material sheet 10 increases when the surface of the negative electrode active material 12 is coated with polyvinylidene fluoride (PVdF) which is the binder 14. From these results, it can be said that the first SEI 16a derived from said LiBOB has a lower electrical resistance than, for example, PVdF coating the surface of the negative electrode active material 12. Thus, it is concluded that the increase in cell resistance can be suppressed by using a lithium-containing compound as the SEI forming agent.

In the above embodiment described above, the technology was described using a case where the battery 100 is a lithium-ion secondary battery as an example. However, the battery 100 does not necessarily have to be a lithium-ion secondary battery. The battery 100 needs only to be a secondary battery that uses the non-aqueous electrolyte 110. That is, the battery 100 needs only be a battery that can be repeatedly charged and discharged using a non-aqueous electrolyte as the electrolyte.

In the embodiment described above, the negative electrode active material sheet 10, together with the negative electrode current collector 122, constitutes the negative electrode 114. However, the negative electrode active material sheet 10 is a freestanding electrode sheet. The freestanding electrode sheet here means an electrode sheet that is supported by itself without requiring a support such as the negative electrode current collector 122. Therefore, the negative electrode 114 does not necessarily need to have the negative electrode current collector 122. That is, as another embodiment, the negative electrode active material sheet 10 may constitute the negative electrode 114 by itself. According to such a configuration, an energy density of the electrode of the negative electrode 114 can be improved.

In the embodiment described above, as shown in FIG. 5, the method of manufacturing the negative electrode 114 comprises the process of fibrillating the binder 14 (S12). However, in a variation, the process of fibrillating the binder 14 may be omitted, in which case a non-fibrillatable material may be employed for the binder 14.

1. A negative electrode sheet for a secondary battery using a non-aqueous electrolyte, the negative electrode sheet comprising:
a negative electrode active material;
a binder; and
a solid electrolyte interphase (SEI) forming agent,
wherein a standard electrode potential of the SEI forming agent is higher than a standard electrode potential of a non-aqueous solvent included in the non-aqueous electrolyte.

2. The negative electrode sheet according to claim 1, wherein the non-aqueous solvent is ethylene carbonate.

3. The negative electrode sheet according to claim 1, wherein the binder includes at least polytetrafluoroethylene.

4. The negative electrode sheet according to claim 1, wherein the SEI forming agent is a compound containing lithium.

5. The negative electrode sheet according to claim 1, wherein the SEI forming agent is at least one selected from the group consisting of lithium bis(oxalato)borate, lithium difluoro(oxalato)borate, and 1,3-propanesultone.

6. A secondary battery, comprising:
a positive electrode;
a negative electrode which comprises the negative electrode sheet according to claim 1; and
a non-aqueous electrolyte which includes ethylene carbonate.

7. A method of manufacturing a negative electrode sheet for a secondary battery using a non-aqueous electrolyte, the method comprising:
producing a negative electrode mixture by mixing a negative electrode active material with a binder and a solid electrolyte interphase (SEI) forming agent; and
producing the negative electrode sheet from the negative electrode mixture,
wherein a standard electrode potential of the SEI forming agent is higher than a standard electrode potential of a non-aqueous solvent included in the non-aqueous electrolyte.

8. A method according to claim 7, wherein the binder incudes polytetrafluoroethylene and at least of a part of the polytetrafluoroethylene is fibrillated in the producing of the negative electrode mixture.
